(19) United States
(12) Patent Application Publication
(10) Pub. No.: US 2015/0060174 A1
(43) Pub. Date: Mar. 5, 2015

(54) IN-WHEEL SYSTEM FOR HYBRID ELECTRIC VEHICLE

(71) Applicant: Hyundai Mobis Co., Ltd., Seoul (KR)

(72) Inventor: Do Hyun Kim, Yongin-si (KR)

(73) Assignee: Hyundai Mobis Co., Ltd., Seoul (KR)

(21) Appl. No.: 14/259,823

(22) Filed: Apr. 23, 2014

(30) Foreign Application Priority Data
Aug. 28, 2013 (KR) 10-2013-0102102

(51) Int. Cl. B60K 7/00; B60K 6/48; B60K 6/50; B60K 28/16

(52) U.S. Cl. CPC B60K 7/0007; B60K 28/16; B60K 6/48; B60K 6/50; Y10S 903/951
USPC 180/197; 180/55; 180/65.25; 903/951

(57) ABSTRACT

Disclosed is an in-wheel system for a hybrid electric vehicle. The in-wheel system includes an engine that provides a rotational driving power to front wheels or rear wheels, at least one in-wheel motor that is driven by a battery, and is provided at each of the front wheels or each of the rear wheels so as to correspond to the wheels to which the driving power of the engine is transmitted to provide a rotational driving power to the same wheels as wheels driven by the engine, and a controller that controls the engine and the in-wheel motor to be driven.

### CROSS-REFERENCE TO RELATED APPLICATION

This application claims priority to and the benefit of Korean Patent Application No. 10-2013-0102102 filed in the Korean Intellectual Property Office on Aug. 28, 2013, the entire contents of which are incorporated herein by reference.

### TECHNICAL FIELD

The present invention relates to an in-wheel system, and more particularly, to an in-wheel system in a hybrid electric vehicle provided with in-wheel motors and an engine as a driving means.

### BACKGROUND OF THE INVENTION

An in-wheel system is a system in which motors are respectively disposed in wheels to perform distributed control without using a large single motor in a fuel cell vehicle, a plug-in hybrid vehicle, and an electric vehicle (EV) using an electric energy as a main power. Further, the in-wheel system is a system in which a driving motor, a braking device, a bearing, and a decelerator are integrated within the wheel. The in-wheel system has technical advantages that energy efficiency thereof is higher than that of a system driven by one high-capacity motor, it is easy to provide an electric four-wheel drive system, and it is possible to improve running stability of a vehicle by independently driving left and right wheels.

In general, the in-wheel system includes a motor that generates a driving power, a cooling device that cools the motor, a decelerator that transmits the driving power of the motor to wheels, a braking device that generates braking force, a steering apparatus that changes a direction of the vehicle, and a suspension supporting the wheels to the vehicle. Such a plurality of components are organically integrated and disposed within the wheel. The in-wheel system typically converts electric energy into a rotational driving power through a stator and a rotor of the motor. After the rotational driving power is decelerated through the decelerator or torque thereof is increased, the rotational driving power is transmitted to a hub, and, thus, a power is transmitted in order of driving the wheels to be rotated.

An in-wheel system in a hybrid electric vehicle according to the related art is provided at rear wheels of the vehicle in a front-wheel drive manner or is provided at front wheels of the vehicle in a rear-wheel drive manner to merely assist the driving power of the engine. That is, since in-wheel motors are provided at towed wheels, the in-wheel system according to the related art merely serves to instantaneously assist the driving (for example, 4WD is instantaneously realized on an icy road) or is partly used in only a regenerative braking mode, and there is a technical limitation that it is difficult to organically combine or operate driving powers of the in-wheel motors and the engine.

### SUMMARY OF THE INVENTION

The present invention has been made in an effort to provide an in-wheel system for a hybrid electric vehicle capable of being effectively operated depending on a situation by organically combining driving powers of an engine and in-wheel motors.

An exemplary embodiment of the present invention provides an in-wheel system for a hybrid electric vehicle includes an engine that provides a rotational driving power to front wheels or rear wheels, at least one in-wheel motor that is driven by a battery, and is provided at each of the front wheels or each of the rear wheels so as to correspond to the wheels to which the driving power of the engine is transmitted to provide a rotational driving power to the same wheels as the wheels driven by the engine, and a controller that controls the engine and the in-wheel motor to be driven.

According to an exemplary embodiment of the present invention, since the in-wheel motors are disposed at the same wheels as driving wheels driven by the engine in the in-wheel system, it is possible to provide various combinations of driving powers by the engine and the in-wheel motors.

Particularly, the in-wheel system according to an exemplary embodiment of the present invention can more conveniently implement various control modes such as the EV running mode, the regenerative braking mode, the LSD control mode and the TCS control mode through cooperation of the engine and the in-wheel motors.

### BRIEF DESCRIPTION OF THE DRAWINGS

FIG. 1 is a schematic diagram illustrating an in-wheel system for a hybrid electric vehicle according to an exemplary embodiment of the present invention.

FIG. 2 is a schematic diagram illustrating an in-wheel system for a hybrid electric vehicle according to another exemplary embodiment of the present invention.

FIGS. 3A and 3B are operation state diagrams illustrating an EV running mode and a driving assist mode in the in-wheel systems for a hybrid electric vehicle of FIGS. 1 and 2.

FIGS. 4A and 4B are operation state diagrams illustrating a regenerative braking mode and a cruise control mode in the in-wheel systems for a hybrid electric vehicle of FIGS. 1 and 2.

FIGS. 5A and 5B are operation state diagrams illustrating a LSD control mode and a TCS control mode in the in-wheel systems for a hybrid electric vehicle of FIGS. 1 and 2.

### DETAILED DESCRIPTION OF THE EMBODIMENTS

Hereinafter, exemplary embodiments of the present invention will be described with reference to the accompanying drawings. However, the following exemplary embodiments are provided to help understanding of the present invention, and the scope of the present invention is not restricted by the following exemplary embodiments. Further, the following exemplary embodiments are provided to more completely describe the present invention to those having ordinary skill in the art. When it is determined that detailed descriptions of known configurations related to the present invention would obscure the technical gist of the present invention, the descriptions thereof will not be presented.

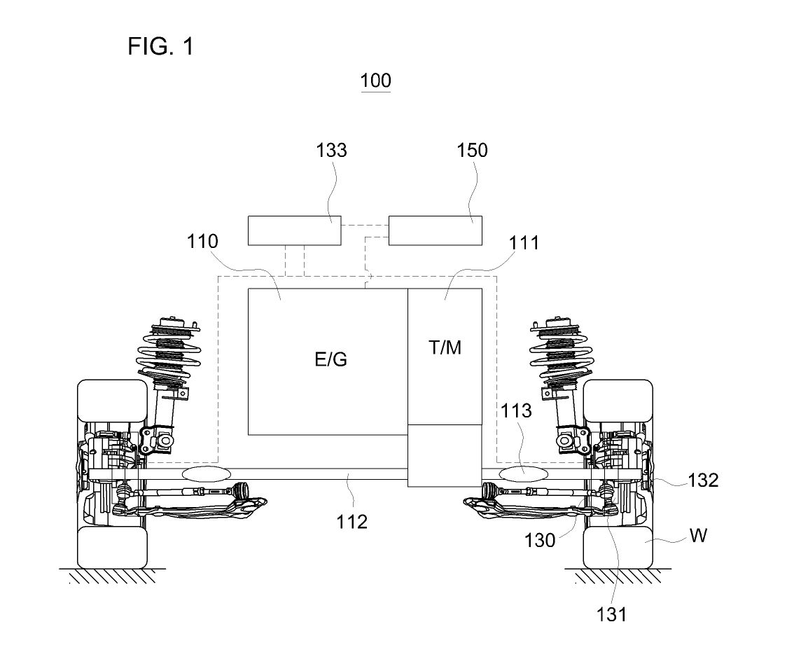

FIG. 1 is a schematic diagram illustrating an in-wheel system for a hybrid electric vehicle according to an exemplary embodiment of the present invention.

FIG. 1 illustrates a case where an in-wheel system for a hybrid electric vehicle (hereinafter, referred to as an in-wheel system 100) according to an exemplary embodiment of the present invention is applied to a front-wheel drive vehicle.

Referring to FIG. 1, the in-wheel system 100 according to the present exemplary embodiment may include in-wheel motors 130 and an engine 110 as a driving means.

The engine 110 may be connected to an axle 112 through a transmission 111 to provide a rotational driving power of the axle 112. The axle 112 may provide the rotational driving power to wheels W through constant velocity joints 113. The axle 112 may be connected to input shafts of the constant velocity joints 113, and output shafts of the constant velocity joints 113 may be connected to hub bearings 132 for driving the wheels W to be rotated.

The in-wheel motors 130 may be respectively disposed in the wheels W. At this time, in the in-wheel system 100 according to the present exemplary embodiment, the wheels W driven to be rotated by the engine 110 may be the same as the wheels W in which the in-wheel motors 130 are disposed. In other words, in the front-wheel drive vehicle illustrated in FIG. 1, the in-wheel motors 130 may be provided at the front wheels W of the vehicle.

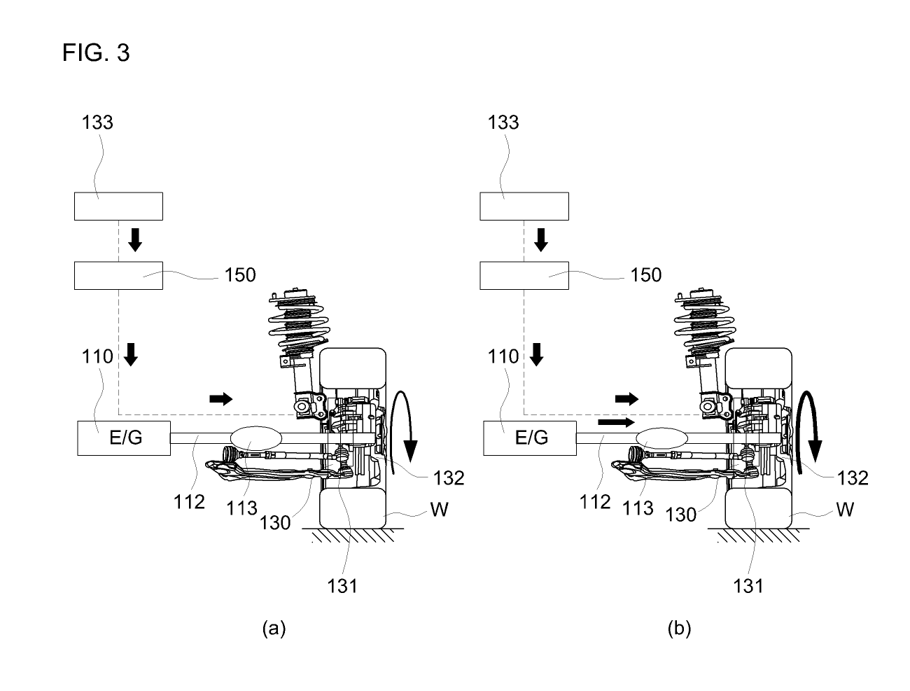

The arrangement of the in-wheel motors 130 is different from that in a general in-wheel system according to the related art in which wheels (for example, front wheels) driven by the engine and wheels (for example, rear wheels) provided with the in-wheel motors are different. Accordingly, in the in-wheel system according to the present exemplary embodiment, since the wheels W can be driven through the engine 110 or the in-wheel motors 130 when necessary, it is possible to easily implement TCS (Traction Control System) control and LSD (Limited Slip Differential) control. The detailed description thereof will be described in the description of the operation of the present exemplary embodiment with reference to FIGS. 3 to 5.

Meanwhile, the in-wheel motor 130 may provide a rotational driving power to the wheel W by a power provided from a battery 133. The driving power of the in-wheel motor 130 may be transmitted to the wheel W through a decelerator 131 and the hub bearing 132. This is a known configuration described in the in-wheel system according to the related art, and thus, the detailed description thereof will not be presented.

The in-wheel system 100 according to the present exemplary embodiment may include a controller 150 for controlling the engine 110 and the in-wheel motors 130. The controller 150 selectively controls the engine 110 or the in-wheel motor 130, or controls both the engine 110 and the in-wheel motor 130 to be used depending on a running condition or a control state. The detailed description thereof will be described in the description of the operation of the present exemplary embodiment with reference to FIGS. 3 to 5.

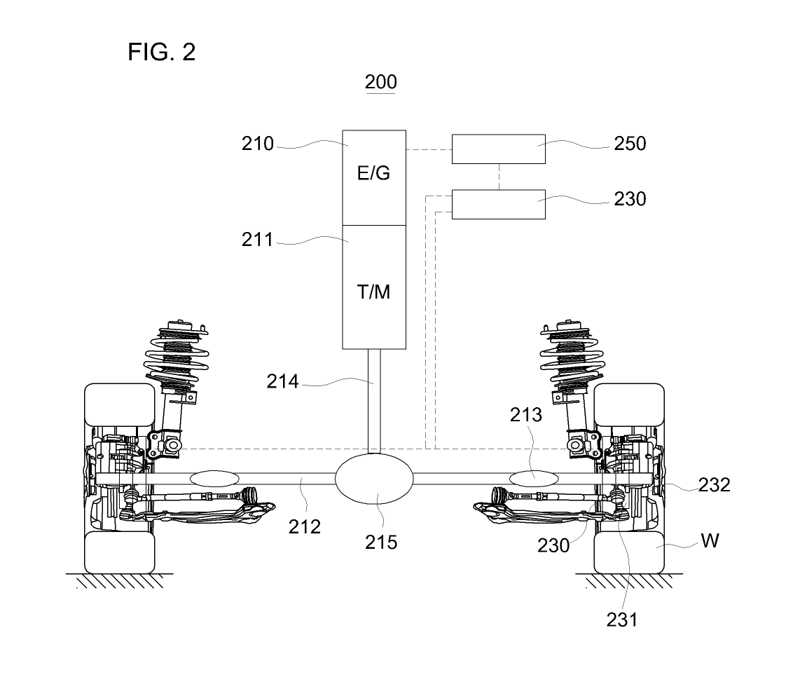

FIG. 2 is a schematic diagram illustrating an in-wheel system for a hybrid electric vehicle according to another exemplary embodiment of the present invention.

FIG. 2 illustrates a case where an in-wheel system 200 is applied to a rear-wheel drive vehicle. However, it should be noted that the in-wheel system 200 according to the present exemplary embodiment has the same technical gist as that of the aforementioned exemplary embodiment described with reference to FIG. 1 and has a configuration similar to the in-wheel system 110 according to the aforementioned exemplary embodiment.

More specifically, the in-wheel system 200 according to the present exemplary embodiment may include in-wheel motors 230 and an engine 210 as a driving means. At this time, all of the engine 210 and the in-wheel motors 230 may transmit the driving power to the same wheels (that, rear wheels). In other words, in the rear-wheel drive vehicle of the present exemplary embodiment, the in-wheel motors 230 may be attached to the rear wheels W of the vehicle.

The engine 210 may be connected to an axle 212 through a transmission 211, a propeller shaft 214 and a differential gear 215 to provide the rotational driving power. The rear-wheel driving vehicle in the present exemplary embodiment is different from the front-wheel driving vehicle in that the propeller shaft 214 and the differential gear 215 are provided. The axle 212 may be connected to input shafts of constant velocity joints 213, and output shafts of the constant velocity joints 213 may be respectively connected to hub bearings 232. Accordingly, the driving power of the engine 210 is transmitted to the constant velocity joints 213 through the axle 212 and is transmitted to the wheels W through the hub bearings 232, so that the wheels W can be driven to be rotated. Such a configuration is similar to that of the front-wheel drive vehicle of FIG. 1.

Meanwhile, the in-wheel motors 230 are respectively disposed in the wheels W to provide the rotational driving power to the wheels W by a power provided from a battery 233. A driving axis of the in-wheel motor 230 is connected to the hub bearing 232 through a decelerator 231, so that the wheel W can be driven to be rotated. Such a configuration is similar to that of the front-wheel drive vehicle of FIG. 1.

FIG. 3 is an operation state diagram illustrating an EV running mode and a driving assist mode in the in-wheel systems for a hybrid electric vehicle of FIGS. 1 and 2.

(a) of FIG. 3 is an operation state diagram illustrating an operation of the in-wheel system 100 in the EV (Electric Vehicle) running mode for driving the wheels W to be rotated by only the driving power of the in-wheel motor 130 and the battery 133, and (b) of FIG. 3 is an operation state diagram illustrating an operation of the in-wheel system 100 in the driving assist mode for assisting the driving power of the engine 110 through the in-wheel motors 130.

For the sake of convenience in description, although the reference numerals of the components used in the exemplary embodiment of FIG. 1 have been represented in FIG. 3, the components of the exemplary embodiment of FIG. 2 may be similarly operated as in the description of FIG. 3.

Referring to (a) of FIG. 3, the in-wheel system 100 according to the present exemplary embodiment may be controlled to be driven in the EV running mode for running the vehicle by only the power of the battery 133. In such a case, the controller 150 stops the driving of the engine 110, and selectively drives only the in-wheel motors 130. The driving wheels W can be driven to be rotated through the in-wheel motors 130.

Meanwhile, referring to (b) of FIG. 3, the in-wheel system 100 according to the present exemplary embodiment may be controlled to be driven or used in the driving assist mode. In such a case, the controller 150 drives all of the engine 110 and the in-wheel motors 130, and the driving power by the engine 110 and the driving power by the in-wheel motor 130 are transmitted to the wheel W. The wheel W can be driven to be rotated.

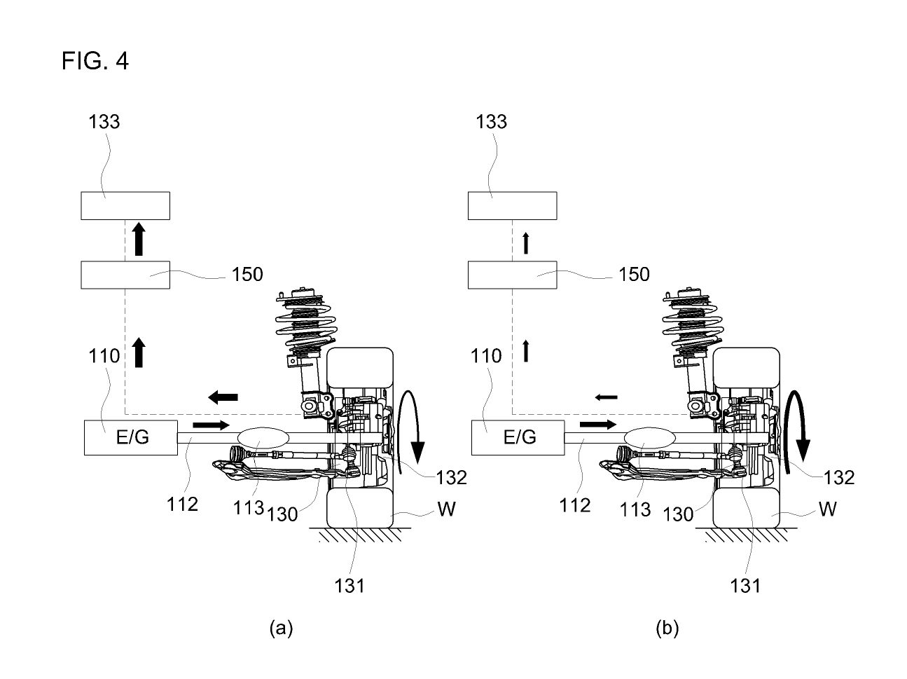

FIG. 4 is an operation state diagram illustrating a regenerative braking mode and a cruise control mode in the in-wheel systems for a hybrid electric vehicle of FIGS. 1 and 2.

(a) of FIG. 4 illustrates an operation of the in-wheel system in the regenerative braking mode, and (b) of FIG. 4 illustrates an operation of the in-wheel system in the cruise control mode. For the sake of convenience in description, the reference numerals of the components used in the exemplary embodiment of FIG. 1 have been represented in the drawing.

Referring to (a) of FIG. 4, when the in-wheel system is in the regenerative braking mode, the controller 150 may selectively stop the driving of the in-wheel motors 130. In this case, the driving axes of the in-wheel motors 130 may be passively rotated by the wheels W and the hub bearings 132, and the in-wheel motors 130 generate a power through rotating of the driving axes, and the power is used to charge the battery 133.

Referring to (b) of FIG. 4, even when the in-wheel system is in the cruise control mode in which the vehicle runs at a constant speed, the driving control may be performed similarly to the aforementioned description. That is, the controller 150 selectively drives only the engine 110 to provide the rotational driving power to the wheels W. Meanwhile, the driving of the in-wheel motors 130 is stopped, and the battery 133 may be charged by the rotation of the wheels W.

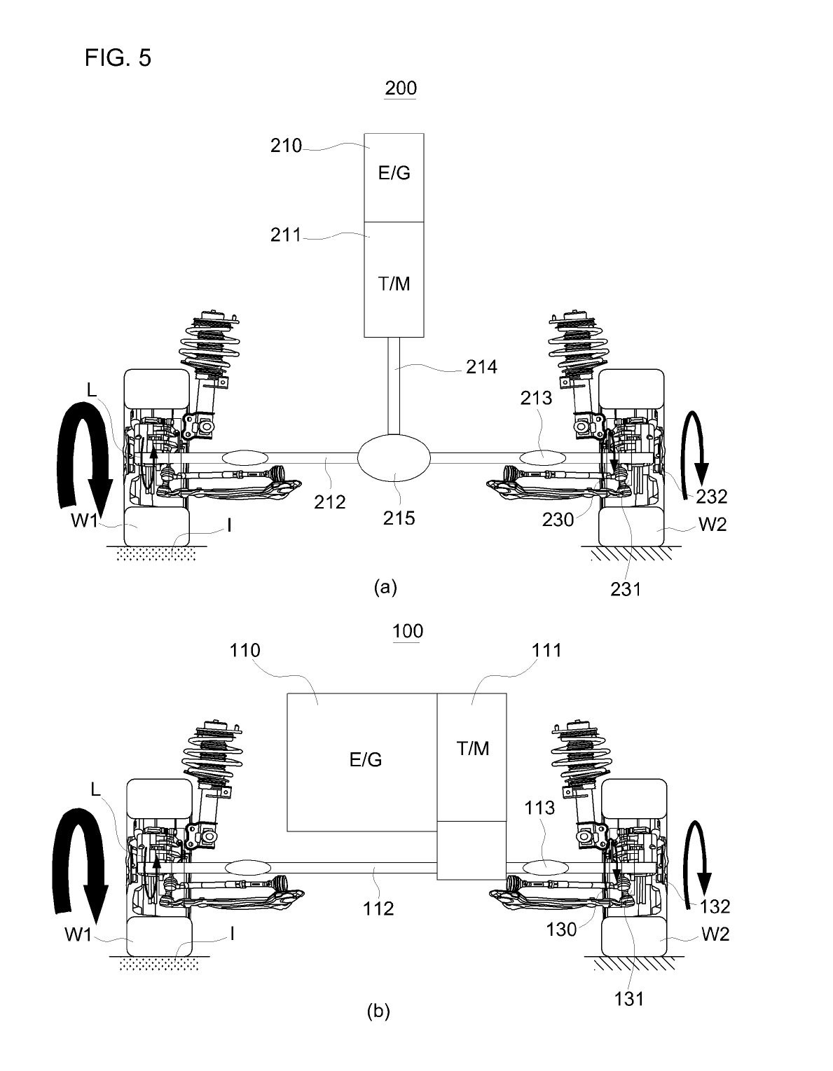

FIG. 5 is an operation state diagram illustrating a LSD control mode and a TCS control mode in the in-wheel systems for a hybrid electric vehicle of FIGS. 1 and 2.

Referring to (a) of FIG. 5, when the vehicle starts after stopping, if there is a difference in frictional force between left and right road surfaces, the in-wheel system 200 according to the present exemplary embodiment can implement the LSD (Limited Slip Differential) control function for preventing one wheel W1 from slipping or idling.

For example, when the vehicle starts after stopping, if one wheel W1 idles on an icy road I, the controller 250 can forcibly apply a load L through the in-wheel motor 130 provided at the one wheel W1. Accordingly, since the driving power is further concentrated on the other wheel W2, the vehicle can normally start.

Meanwhile, referring to (b) of FIG. 5, when there is a difference in frictional force between left and right road surfaces, the in-wheel system 100 according to the present exemplary embodiment can easily implement the TCS (Traction Control System) control function for preventing a posture of the vehicle from being destabilized.

For example, when one wheel W1 slips on the icy road during the running or turning of the vehicle, posture stability and running stability of the vehicle are degraded. In such a case, the controller 150 selectively generates the load L through the in-wheel motor 130 of the slipping wheel W1, and the driving power is equally distributed to the left and right wheels W1 and W2. Accordingly, it is possible to improve the posture stability and running stability of the vehicle.

As described above, in the in-wheel systems according to the exemplary embodiments of the present invention, since the in-wheel motors are disposed at the same wheels as the driving wheels driven by the engine, it is possible to provide various combinations of driving powers by the engine and the in-wheel motors. Particularly, the in-wheel systems according to the exemplary embodiments of the present invention can more conveniently implement various control modes such as the EV running mode, the regenerative braking mode, the LSD control mode and the TCS control mode through cooperation of the engine and the in-wheel motors. In addition, since existing LSD equipment and a TCS sensor can be removed, it is possible to reduce a weight of the vehicle and manufacturing cost.

Although an exemplary embodiment of the present invention has been described, those skilled in the art will variously modify and change the present invention through supplement, change, deletion, addition of the constituent element, and the like, without departing from the spirit of the present invention defined in the claims, and the modification and the change will belong to the scope of the right of the present invention.

1. An in-wheel system for a hybrid electric vehicle, comprising:
an engine that provides a rotational driving power to front wheels or rear wheels;
at least one in-wheel motor that is driven by a battery, and is provided at each of the front wheels or each of the rear wheels so as to correspond to the wheels to which the driving power of the engine is transmitted to provide a rotational driving power to the same wheels as the wheels driven by the engine; and
a controller that controls the engine and the in-wheel motor to be driven.

2. The in-wheel system for a hybrid electric vehicle of claim 1, wherein the engine provides the rotational driving power to the front wheels, and
the in-wheel motor is provided at each of the front wheels to provide the rotational driving power to each of the front wheels.

3. The in-wheel system for a hybrid electric vehicle of claim 1, wherein the engine provides the rotational driving power to the rear wheels, and
the in-wheel motor is provided at each of the rear wheels to provide the rotational driving power to each of the rear wheels.

4. The in-wheel system for a hybrid electric vehicle of claim 1, wherein the engine transmits the rotational driving power to the front wheels or the rear wheels through an axle and constant velocity joints connected to the axle,
an output shaft of the constant velocity joint is connected to a hub bearing, and
a driving axis of the in-wheel motor is connected to the hub bearing to transmit the rotational driving power to each of the front wheels or each of the rear wheels.

5. The in-wheel system for a hybrid electric vehicle of claim 1, wherein in an EV (Electric Vehicle) running mode,
the controller stops driving of the engine, and
the in-wheel motor drives each of the front wheels or each of the rear wheels to be rotated by a power from the battery.

6. The in-wheel system for a hybrid electric vehicle of claim 1, wherein in a driving assist mode,
the controller drives both the engine and the in-wheel motor, and
the front wheels or the rear wheels are driven to be rotated by the rotational driving powers of the in-wheel motor and the engine.

7. The in-wheel system for a hybrid electric vehicle of claim 1, wherein in a regenerative braking mode or a cruise control mode,
the controller stops driving of the in-wheel motor, and
the driving axis of the in-wheel motor is passively rotated to charge the battery.

8. The in-wheel system for a hybrid electric vehicle of claim 1, wherein in a LSD (Limited Slip Differential) control mode or a TCS (Traction Control System) control mode,
the controller controls the in-wheel motor to apply a load to a slipping or idling wheel.

9. An in-wheel system for a hybrid electric vehicle, comprising:
an engine that provides a rotational driving power to front wheels or rear wheels; and
in-wheel motors that are driven by a battery, and are provided at the front wheels or the rear wheels so as to correspond to the wheels to which the driving power of the engine is transmitted to provide a rotational driving power to the same wheels as the wheels driven by the engine,
wherein the engine and the in-wheel motors are independently driven, and the engine and the in-wheel motors are driven together, or any one of the engine or the in-wheel motors is selectively driven.

10. The in-wheel system for a hybrid electric vehicle of claim 9, wherein in an EV (Electric Vehicle) running mode,
driving of the engine is stopped, and
the in-wheel motors drives the front wheels or the rear wheels to be rotated by a power from the battery.

11. The in-wheel system for a hybrid electric vehicle of claim 9, wherein in a driving assist mode,
all of the engine and the in-wheel motors are driven, and
the front wheels or the rear wheels are driven to be rotated by the rotational driving powers of the engine and the in-wheel motors.

12. The in-wheel system for a hybrid electric vehicle of claim 9, wherein in a regenerative braking mode or a cruise control mode,
driving of the engine is stopped, and
driving axes of the in-wheel motors are passively rotated to charge the battery.

13. The in-wheel system for a hybrid electric vehicle of claim 9, wherein in a LSD (Limited Slip Differential) control mode or a TCS (Traction Control System) control mode,
the in-wheel motor applies a load to a slipping or idling wheel.

14. The in-wheel system for a hybrid electric vehicle of claim 9, wherein the engine provides the rotational driving power to the front wheels, and
the in-wheel motors are provided at the front wheels to provide the rotational driving power to the front wheels.

15. The in-wheel system for a hybrid electric vehicle of claim 9, wherein the engine provides the rational driving power to the rear wheels, and
the in-wheel motors are provided at the rear wheels to provide the rotational driving power to the rear wheels.
